(19) United States
(12) Patent Application Publication
(10) Pub. No.: US 2010/0068352 A1
(43) Pub. Date: Mar. 18, 2010

(54) Venting mechanism for a microwave flexible package

(75) Inventors: Dennis Lonergan, Long Lake, MN (US); Arthur Davis, Bloomington, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Sholl Group II, Inc., Eden Prairie, MN (US)

(21) Appl. No.: 12/210,578

(22) Filed: Sep. 15, 2008

(51) Int. Cl. B65D 85/00; A23P 1/00

(52) U.S. Cl. 426/106; 426/665

(57) ABSTRACT

An improved package comprising a self-venting mechanism that provides an indication of high temperature venting. The package includes a fin seal with an aperture positioned in the fin seal to act as a vent when the package and its contents are heated in a microwave oven. The pressure in the package is vented by allowing steam to escape through the aperture upon partial separation of the fin seal up to the aperture.

### BACKGROUND OF THE INVENTION

Currently there are many types of packages in which food is purchased. It is often desirable to be able to heat and/or cook food in the same packaging in which it is purchased. This can prove challenging when the method of heating employs a microwave oven. When food is heated in a substantially closed container in a microwave oven, pressure builds within the package due to the production of steam. It is therefore advantageous to have a package that provides a mechanism that will allow the release of steam from the package to avoid rupturing the package.

Packages exist that allow heating and/or cooking of the food within the package in a microwave oven through the use of a vent. The most common of these packages are microwaveable popcorn packages. Typically, the microwaveable popcorn package has a preformed steam vent which has an opening at the same position where the package is to be opened once the popcorn is popped. This results in the consumer experiencing hot steam coming out from inside the package as the consumer opens the package.

Another type of package exists that employs a standard side seal on a microwaveable flexible pouch. Such a package is described in US Published Patent Application 2005/0276885. Once the side seal is formed in the pouch, an aperture is formed through the panels that make up the side seal. The aperture is to perform as a steam vent with the seal separating up to the aperture as steam pressure builds up in the package. The aperture also doubles as a way of hanging the pouch on a hanger or store display. However, it has been found that this seal with the aperture ruptures past the seal during microwave heating in a fin seal type package.

### SUMMARY OF THE INVENTION

The present invention includes a package for containing food and heating food in a microwave oven. The package includes a fin seal, wherein the fin seal has an aperture positioned to act as a vent when the package and its contents are heated in a microwave oven. The aperture provides a reliable venting location so the user is alerted as to which portion of the packaging may expose the user to escaping high temperature steam.

### BRIEF DESCRIPTION OF THE DRAWINGS

FIG. 1 is a perspective view of a package of the present invention.

FIG. 2 is a perspective view of a step of producing the package of the present invention.

FIG. 3 is perspective view of the subsequent steps of producing the package of the present invention.

FIG. 4 is a perspective view of still a further step of the process of making the package of the present invention.

FIG. 5 is a perspective view of still another step of the process of making the package of the present invention.

FIG. 6 is a perspective view illustrating the package in a microwave oven.

### DETAILED DESCRIPTION OF THE PREFERRED EMBODIMENTS

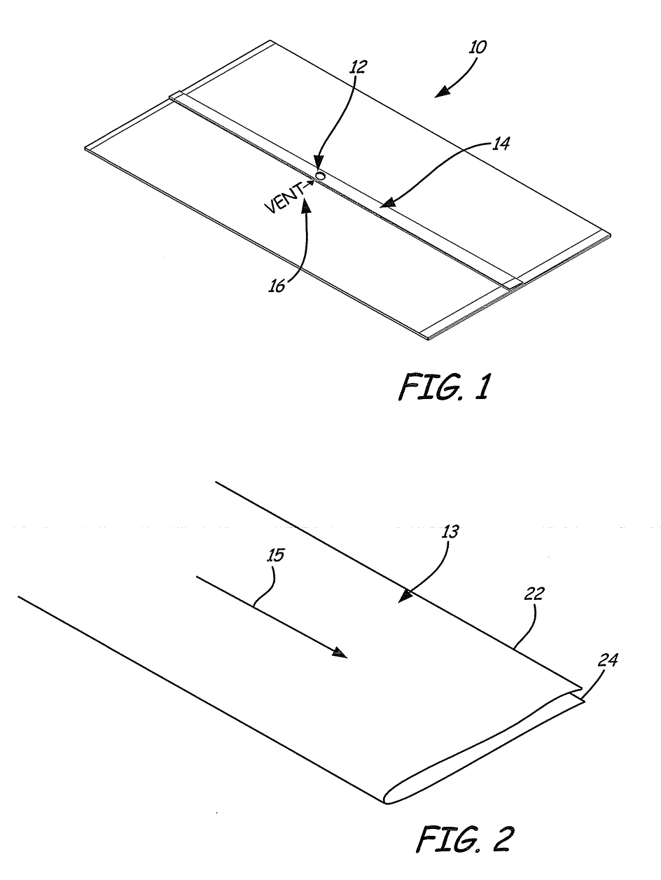

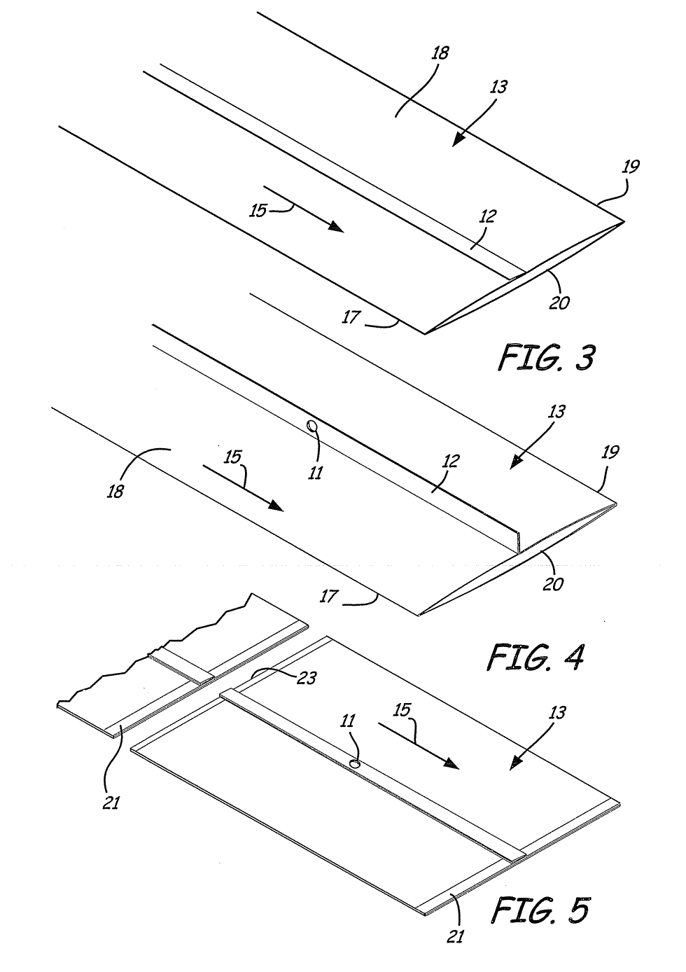

A venting mechanism for a microwaveable flexible package is generally illustrated at 10 in FIG. 1. The package of this invention includes a safety vent mechanism 12 positioned in a fin seal 14. The safety vent mechanism 12 is identified by indicia 16 which inform the user where hot steam is being vented from the package 10. Positioning the vent in the fin seal 14 eliminates rupturing of the package 12 during microwaving of the food as further explained herein.

The package 12 in most aspects is a typical food package suitable for cooking food in a microwave. The package is made from a continuous sheet 13 of flexible polymeric film as illustrated in FIG. 2 that is moving in the general direction of arrow 15. Typically, such packaging is made of multi-layered polymeric films with some layers acting as oxygen barriers, while others, especially the interior layer acting as an adhesive layer to form the package.

For purposes of this application, the fin seal 14 is a seal that is formed by placing edge sections 22 and 24 of the sheet 13 on each other as the sheet 13 moves in the direction of arrow 15. The edge sections 22 and 24 are adhesively secured to each other using a conventional process that is well known. In doing so, the package 10 is sealed along the edge sections 22 and 24 to form a “fin” seal. The methods used to seal edge portions 22 and 24 include heat, ultrasonic or adhesive sealing techniques or any combination thereof.

Once the fin seal is formed, the film moving in the general direction of arrow 15 is folded to form folded edges 17 and 19 which then define opposing walls 18 and 20 of the package. The fin seal 12 generally lies flat adjacent the wall 18.

As further illustrated in FIG. 4, a vent hole 11 is formed in the fin seal 12 (which is illustrated in a vertical position). Once the vent hole 11 is formed, the film 13 is then sealed and cut to form a sealed bottom edge 21. Preferably, the vent hole is formed by a cutting action that does not seal the edges of the vent hole. Hot needle punching will for example seal the edges of the vent hole (melt the edges of the polymer layer or layers in addition to the sealing layer) which may stop the steam from escaping through the vent hole. A mechanical punching mechanism or other mechanism which cuts through the two layers of film 13 without the use of heat and/or does not seal the edges of the vent hole will permit steam to escape through the vent hole.

The top edge of the package 23 remains in an open position and will be sealed once the package is filled with food, such as vegetables.

The seal 12 is formed such that once steam is created during the microwaving process, and sufficient pressure is built up within the package, the fin seal will start to separate. The fin seal will start to separate until the separation reaches the vent hole 28. Once the separation of the fin seal reaches the vent hole 28, steam is released from the package.

Since the integrity of the fin seal is not compromised during microwave heating, the contents of the package stay within. In this way, the food being microwaved within the package does not escape the package. Due to the indicia warning of the location of the vent, the user of the microwave package knows where on the package that the steam is being vented, and can then avoid the hot steam coming out of the package.

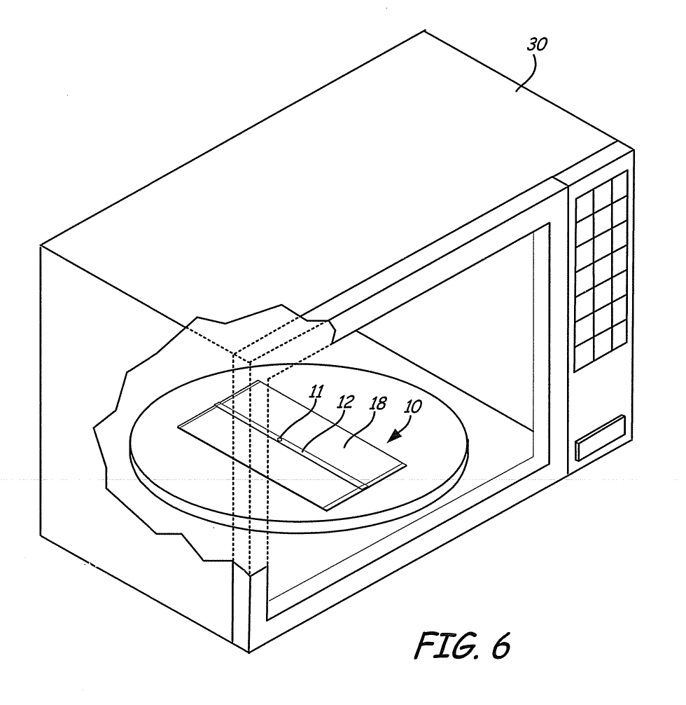

In use, the package 10 containing food to be heated is placed in a microwave oven 30 as illustrated in FIG. 6. The package is placed with the fin seal facing upwardly. The wall 18 faces towards the top of the oven 13. When the package is heated, the water that is within the food or within the package is heated and vaporizes to form steam. The steam then builds pressure within the package. As the pressure inside the package increases, the fin seal weakens and separates until it reaches the vent hole 11. Once the separation reaches the vent hole 11, steam is released through the vent hole.

In a preferred embodiment of this invention, the fin seal 14 is about 12 mm wide and extends the entire length of one side of the package 10. The vent hole 11 should be of a size sufficient to allow steam to be released to eliminate further pressure building within the package. In a preferred embodiment, the vent hole 11 is circular in shape but other shapes are within the scope of this invention. Vent hole sizes ranging from 1.6 mm to 6.0 mm in diameter produced the best results.

To a certain extent, the rate of steam production within the package will be a function of the moisture content of the food product within. In view of this, the vent hole diameter may have to be adjusted to accommodate the amount of steam being produced and being vented during microwaving.

Although the present invention has been described with reference to preferred embodiments, workers skilled in the art will recognize that changes may be made in form and detail without departing from the spirit and scope of the invention.

What is claimed:

1. A self-venting package for retaining food and for heating food in a microwave oven, the package comprising:
first and second opposing walls and a fin seal wherein the fin seal has an aperture positioned to act as a vent when the package and its contents are heated in a microwave oven.

2. The self-venting package of claim 1 wherein the fin seal is separable sufficiently to permit steam created within the package to vent through the aperture.

3. The self-venting package of claim 1 and further comprising indicia identifying the aperture as a steam vent.

4. The self-venting package of claim 1 wherein the fin seal comprises about 12 mm in width.

5. The self-venting package of claim 1 wherein the aperture comprises a circular shape.

6. The self-venting package of claim 5 wherein the aperture ranges between about 1.6 mm and about 6.0 mm in diameter.

7. The self-venting package of claim 1 wherein the vent hole is formed by a punch that cuts through the fin seal.

8. A method for making a self-venting package for retaining and heating food in a microwave oven, the method comprising:
sealing opposing edge portions of a sheet of flexible material to form a sealed edge portion;
forming an aperture in the sealed edge portion to act as a steam vent.

9. The method of claim 8 and further sealing two other opposing edge portions to form an interior pouch capable of holding food during microwaving.

10. The method of claim 8 and further comprising providing indicia proximate the aperture to warn of high venting temperatures.

11. The method of claim 8 wherein the aperture is formed by a cutting action without the use of heat.

12. The method of claim 8 wherein the flexible material has a sealing layer and other layers and wherein the aperture has an edge and the aperture being formed without sealing the other layers along the edges of the aperture.
